(19) United States
(12) Patent Application Publication
(10) Pub. No.: US 2025/0258704 A1
(43) Pub. Date: Aug. 14, 2025

(54) DISTRIBUTED TASK QUEUING AND PROCESSING FOR LIGHTWEIGHT EDGE DEVICES

(71) Applicant: Red Hat, Inc., Raleigh, NC (US)

(72) Inventors: Leigh Griffin, Waterford (IE); Paolo Antinori, Milan (IT)

(21) Appl. No.: 18/441,980

(22) Filed: Feb. 14, 2024

(51) Int. Cl. G06F 9/48; G06F 9/50

(52) U.S. Cl. CPC G06F 9/4881; G06F 9/5038

(57) ABSTRACT

Techniques for assigning tasks among networked devices/nodes e.g., edge devices using an automation controller are disclosed. A manager node executing the automation controller may provide a global task queue of tasks to be assigned to a plurality of execution nodes. In response to receiving a new task to be assigned, the manager node may compare resource metadata associated with the new task, a priority of the new task and device metrics for each of the plurality of execution nodes, wherein the device metrics for each of the plurality of execution nodes indicate a resource availability of the execution node and a status of a local task queue associated with the execution node. The manager node may determine, based on the comparison, a particular execution node among the plurality of execution nodes to assign the new task to.

### TECHNICAL FIELD

Aspects of the present disclosure relate to task allocation in edge and other systems, and specifically to intelligent task allocation using an automation controller.

### BACKGROUND

A container orchestration engine (such as the Redhat™ OpenShift™ module) may be a platform for developing and running containerized applications and may allow applications and the data centers that support them to expand from just a few machines and applications to thousands of machines that serve millions of clients. Container orchestration engines may provide an image-based deployment module for creating containers and may store one or more image files for creating container instances. Many application instances can be running in containers on a single host without visibility into each other's processes, files, network, and so on.

Automation controllers are suites of software tools that can be used to automate a variety of operations related to computing resources, including configuration management, application deployment, cloud provisioning, task execution, network automation, and multi-node orchestration. In the past, such operations would generally be performed by a human operator that logs into a computing system to manually perform tasks. As computing infrastructure increases in size and complexity, the manual performance of these tasks may become time consuming and error prone. The automation provided by automation controllers can be used to orchestrate changes over thousands of devices while reducing the level of human involvement in provisioning, installing, configuring, and maintaining computing resources. One example of such an automation controller is the Red Hat™ Ansible™ Automation Platform.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system, in accordance with some embodiments of the present disclosure.

FIG. 2 is a block diagram illustrating the example system of FIG. 1, with a manager node collecting device metrics from different computing nodes, in accordance with some embodiments of the present disclosure.

FIG. 3 is a block diagram illustrating the example system of FIG. 1, with a manage node assigning a new task based on device metrics for different compute nodes, task metadata and task priority, in accordance with some embodiments of the present disclosure.

FIG. 4 is a flow diagram of a method for assigning tasks using an automation controller, in accordance with some embodiments of the present disclosure.

FIG. 5 is a block diagram of an example computing device that may perform one or more of the operations described herein, in accordance with some embodiments of the present disclosure.

### DETAILED DESCRIPTION

An edge device is a device that provides an entry point into enterprise or service provider core networks. Examples of edge devices include assembly line tools, IoT gateways, points of sale, and industrial controllers. Edge devices can also be hard to access, or located in settings with little or no on-site technical expertise. Edge devices often operate with limited computing resources, power, cooling, and connectivity. This impacts their ability to efficiently manage multiple complex task queues that need to collect, process and respond to local data in a timely manner. A challenge is the lack of an intelligent task allocation system which can cause resource starvation, resulting in system performance issues that can have severe consequences, especially in domains such as medical and automotive.

The present disclosure addresses the above-noted and other deficiencies by providing techniques for assigning tasks among networked devices/nodes e.g., edge devices using an automation controller such as Ansible. A manager node executing the automation controller may provide a global task queue of tasks to be assigned to a plurality of execution nodes. In response to receiving a new task to be assigned, the manager node may compare resource metadata associated with the new task, a priority of the new task and device metrics for each of the plurality of execution nodes, wherein the device metrics for each of the plurality of execution nodes indicate a resource availability of the execution node and a status of a local task queue associated with the execution node. The manager node may determine, based on the comparison, a particular execution node among the plurality of execution nodes to assign the new task to.

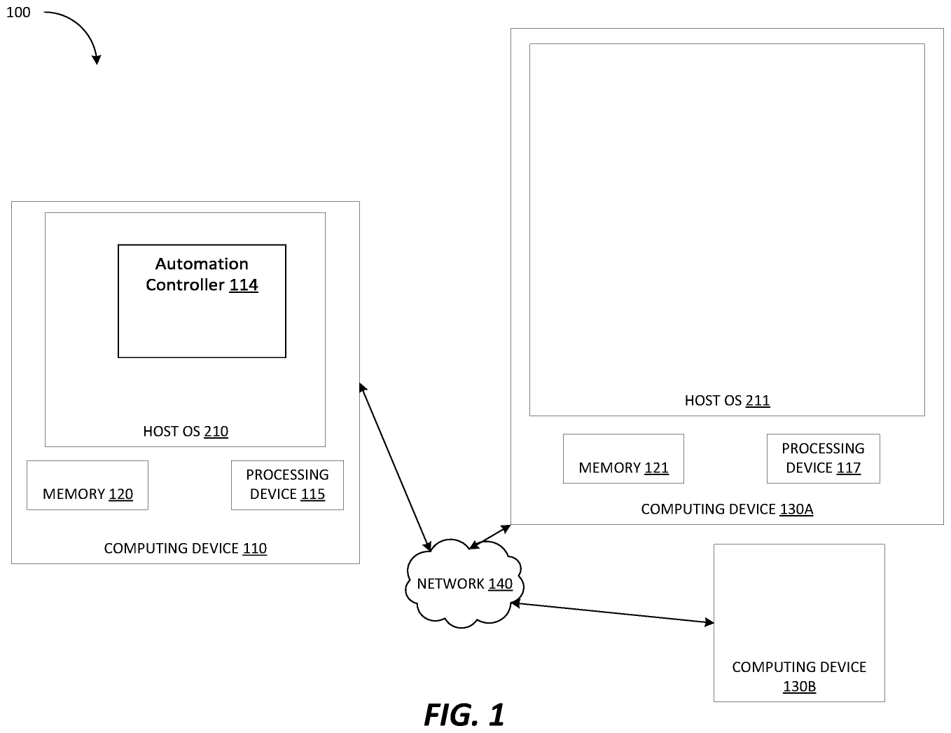

FIG. 1 is a block diagram that illustrates an example system 100. As illustrated in FIG. 1, the system 100 includes a computing device 110, and a plurality of computing devices 130. The computing devices 110 and 130 may be coupled to each other (e.g., may be operatively coupled, communicatively coupled, may communicate data/messages with each other) via network 140. Network 140 may be a public network (e.g., the internet), a private network (e.g., a local area network (LAN) or wide area network (WAN)), or a combination thereof. In one embodiment, network 140 may include a wired or a wireless infrastructure, which may be provided by one or more wireless communications systems, such as a WiFi™ hotspot connected with the network 140 and/or a wireless carrier system that can be implemented using various data processing equipment, communication towers (e.g., cell towers), etc. In some embodiments, the network 140 may be an L3 network. The network 140 may carry communications (e.g., data, message, packets, frames, etc.) between computing device 110 and computing devices 130. Each computing device may include hardware such as processing device 115 (e.g., processors, central processing units (CPUs), memory 120 (e.g., random access memory (RAM), storage devices (e.g., hard-disk drive (HDD), solid-state drive (SSD), etc.)), and other hardware devices (e.g., sound card, video card, etc.). In some embodiments, memory 120 may be a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. Memory 120 may be configured for long-term storage of data and may retain data between power on/off cycles of the computing device 110. Each computing device may comprise any suitable type of computing device or machine that has a programmable processor including, for example, server computers, desktop computers, laptop computers, tablet computers, smartphones, set-top boxes, etc. In some examples, each of the computing devices 110 and 130 may comprise a single machine or may include multiple interconnected machines (e.g., multiple servers configured in a cluster). The computing devices 110 and 130 may be implemented by a common entity/organization or may be implemented by different entities/organizations. For example, computing device 110 may be operated by a first company/corporation and one or more computing devices 130 may be operated by a second company/corporation. Each of computing device 110 and computing devices 130 may execute or include an operating system (OS) such as host OS 210 and host OS 211 of computing device 110 and 130A respectively, as discussed in more detail below. The host OS of a computing device 110 and 130 may manage the execution of other components (e.g., software, applications, etc.) and/or may manage access to the hardware (e.g., processors, memory, storage devices etc.) of the computing device.

In some embodiments, the system 100 may be configured as a scalable, distributed computing system, such as a container orchestration platform. A container orchestration platform is a platform for developing and running containerized applications and may allow applications and the data centers that support them to expand from just a few machines and applications to thousands of machines that serve millions of clients. Container orchestration platforms may provide an image-based deployment module for creating containers and may store one or more image files for creating container instances. In some embodiments, the computing device 110 may implement a control plane of a container orchestration platform while computing devices 130 may each implement a compute node of the container orchestration engine. Many application instances can be running in containers on a single host without visibility into each other's processes, files, network, and so on. Each container may provide a single function (often called a “service”) or component of an application, such as a web server or a database, though containers can be used for arbitrary workloads. The container orchestration platform may scale a service in response to workloads by instantiating additional containers with service instances in response to an increase in the size of a workload being processed by the nodes. One example of a container orchestration platform in accordance with embodiments is the Red Hat™ OpenShift™ platform built around Kubernetes.

By their nature, containerized applications are separated from the operating systems where they run and, by extension, their users. The control plane 216 may expose applications to internal and external networks by defining network policies that control communication with containerized applications (e.g., incoming HTTP or HTTPS requests for services inside the cluster 131).

A typical deployment of a container orchestration platform may include a control plane (e.g., computing device 110) and a cluster of worker nodes, (e.g., computing devices 130). The worker nodes may run the aspects of the container orchestration platform that are needed to launch and manage containers, pods, and other objects. For example, a worker node may be a physical server that provides the processing capabilities required for running containers in the environment. A worker node may also be implemented as a virtual server, logical container, or GPU, for example.

The computing devices 130 may be edge devices such as assembly line tools, IoT gateways, points of sale, and industrial controllers that have to operate with limited computing resources, power, cooling, and connectivity. They can also be hard to access, or in settings with little or no on-site technical expertise. In some embodiments, the computing devices 130 may form a domain. A domain may include of a group of devices that share the same configuration, policies, and identity stores. The shared properties allow the devices within the domain to be aware of each other and operate together. The computing devices 130 may all be individual devices that are a part of a domain representing e.g., a fleet of internet of things (IoT) devices.

The computing device 110 may include an automation controller 114 which may comprise an automation tool such as Red Hat Ansible™, which is an open-source automation tool that allows users to automate the configuration, management, and deployment of systems and applications such as a cluster of worker nodes. The automation controller 114 may allow users to define their infrastructure as code using e.g., Yet Another Markup Language (YAML), which is a declarative language. The automation controller 114 may use a client-server architecture, where a central machine, known e.g., as the control node (computing device 110 in the example of FIG. 1), manages and orchestrates the automation process. The control node connects to target nodes (computing devices 130 in the example of FIG. 1) over Secure Shell protocol (SSH) or other protocols and executes tasks that are included in “playbooks.” Ansible playbooks define a set of tasks and configurations to be executed on remote systems. A playbook includes one or more plays, and each play includes a set of tasks. Plays are a collection of tasks that are executed together on a group of hosts or a set of hosts defined by patterns. Tasks within a playbook define actions to be performed on the target devices, such as installing packages, copying files, starting, or stopping services, executing commands, configuring network settings, etc. Although discussed herein as an automation tool, the automation controller 114 could also be implemented as an infrastructure as code (IaC) tool such as Terraform and Otter, for example.

The automation controller 114 may be coupled to a database of automation data (not shown) that can be used to create a playbook. For example, the automation data may include an inventory of target nodes, scripts and/or code modules to be executed on the target nodes, and other information. The playbook may be initiated manually by the user or in accordance with a schedule defined by the user. A playbook may be sent by the automation controller 114 to a computing device 130 which executes the playbook and collects status information (as part of the functionality defined by the playbook). In some embodiments, the computing device 130 may be configured to launch one or more containers for executing the playbook in a distributed computing system.

The playbook may be configured to perform any of a variety of automated tasks, such as executing software updates (e.g., patches), implementing configuration changes, provisioning cloud resources, and others. For example, the playbook may be configured to perform tasks related to a user's Information Technology (IT) infrastructure, such as provisioning infrastructure, improving security and compliance, installing software, patching system, and others. In some embodiments, the playbook may be configured to target devices that may not have consistent and reliable access to the network 140, such as automobiles or other types of vehicles (e.g., ships, boats, planes, tractor-trailers, etc.). Those of ordinary skill in the art will recognize a wide variety of additional applications for the techniques described herein.

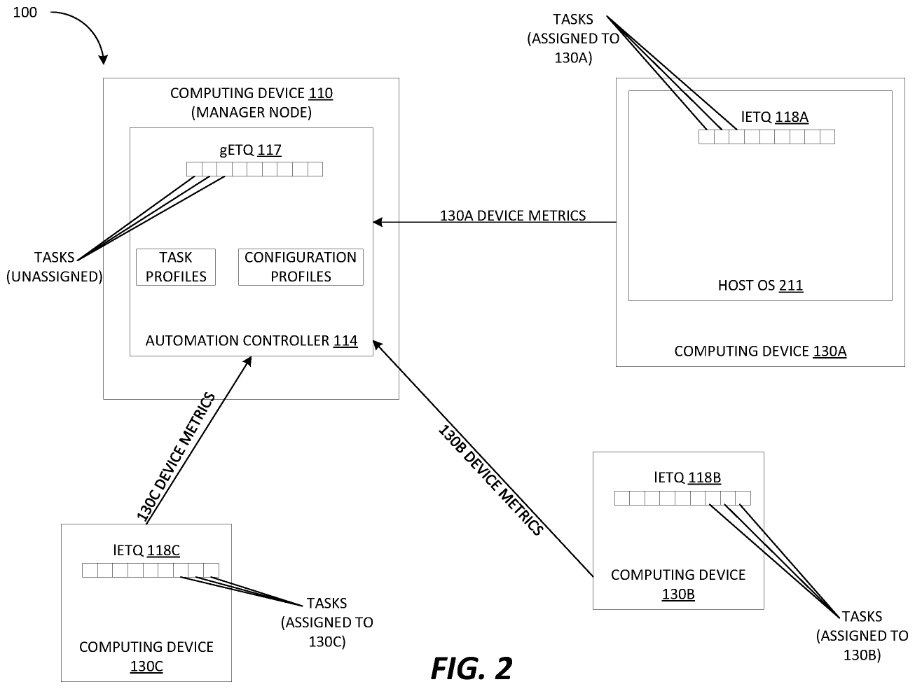

FIG. 2 illustrates the system 100 in accordance with some embodiments of the present disclosure, where the computing device 110 (also referred to herein as the “manager node 110”) uses the functionality of the automation controller 114 to load balance the entire network of computing devices 130 (also referred to herein as execution nodes 130) based on the administrative priority of tasks that need to be executed (e.g., CVE updates, firmware updates) and the compute capabilities of each computing device 130 as discussed in further detail herein. The manager node 110 may implement a global edge task queue (gETQ) 117 that includes a master set of tasks that need to be performed (have yet to be assigned), and may potentially be performed on any of the computing devices 130. Example tasks include CVE updates, firmware updates, building a database, retrieving a record, and polling data from a sensor. Each computing device 130 may implement a local edge task queue (IETQ) 118 that includes a set of tasks that have been assigned to the computing device 130 for execution. Each computing device 130's IETQ 118 may function both as a runtime log to keep track of the work the computing device 130 device is doing, but also to provide information for the manager node 110 to understand the computing device 130's workload as discussed in further detail herein.

When a computing device 130 completes a task, it may send device metrics including current resource availability and a status of its IETQ 118 to the manager node 110 (i.e., information about its current workload). It should be noted that some tasks may not be simply executed once and completed, but may be on-going tasks such as polling data from a sensor. For these types of tasks, the computing device 130 may send device metrics once it has begun executing the task (to account for the resources used executing the task) and periodically thereafter. The information about a computing device 130's current workload may include the number of tasks it is currently executing (and their priority) and the number of tasks currently in its IETQ 118 and the priority of each of the tasks currently in its IETQ 118. It should be noted that a computing device 130 may not remove an on-going task from its IETQ 118 once it begins execution of the task. This is because in scenarios where the task gets paused or interrupted (e.g., due to connectivity breaks or compute resource issues), keeping the task on the local queue allows for a quicker restart and maintaining of the task's priority. The resource availability of a computing device 130 may include availability of resources of the computing device 130 such as available battery, available computing power (e.g., available processing cores, available CPU cycles), available memory, and available bandwidth among others. For example, a computing device 130 may send device metrics indicating e.g., that it is at 20% battery, currently has 1 processing core available, currently has 2 MB of ram available, currently has 300 MB of bandwidth available, is currently executing two other tasks (and the type/priority of tasks it is executing), and currently has 3 additional tasks in its IETQ 118 (and the type/priority of the tasks in its IETQ 118).

The manager node 110 may store the device metrics received from each computing device 130 and update the device metrics for each computing device 130 as updated devices metrics are received from that computing device 130. The manager node 110 may also have, for each task in the gETQ 117, a task profile that includes resource metadata indicating the resource impact (on a type-by-type basis) of the task. The task profile for each task may indicate that the task requires e.g., X MB of ram, Y CPU cycles, Z IOPS, W bandwidth etc. The manager node 110 may compare the task profile of a particular task in the gETQ 117, the priority of the particular task and the device metrics of each computing device 130 to determine a suitable computing device 130 for the particular task as discussed in further detail herein.

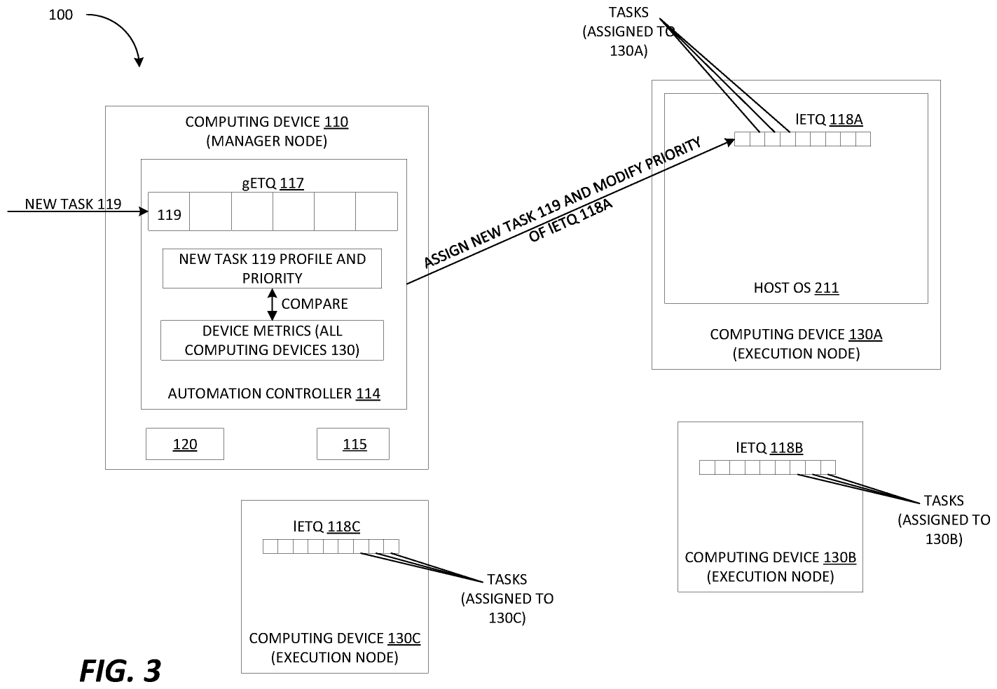

As shown in FIG. 3, when a new task 119 is received by the manager node 110, the manager node 110 may put the new task into the gETQ 118 and may assess the new task's priority and the status of all computing devices 130 (based on the most recently received device metrics of each computing device 130). More specifically, the manager node 110 may compare the task profile of the new task 119 and the assessed priority of the new task 119 with the device metrics of each the computing devices 130 to determine the optimal computing device 130 to assign the new task to. In the examples described herein, the priority of a task may be indicated as “high,” “medium,” or “low.” However, this is for ease of description only and the priority of a task may be indicated in any appropriate manner. In the example of FIG. 3, the new task 119 may be a high priority task.

The manager node 110 may compare the task profile of the new task 119 to the device metrics for each computing device 130 to determine a subset of computing devices 130 that currently have sufficient available resources to execute it. This is because the new task 119 is high priority, and so the manager node 110 may only consider computing devices 130 that currently have sufficient resources to execute it. However, if a new task is medium or low priority, the manager node 110 may consider computing devices 130 that do not currently have sufficient resources. For example, if all computing devices 130 are currently resource strained, the manager node 110 may assign the new task to the computing device 130 with the shortest IETQ 118 since the new task is medium or low priority and therefore does not need to be executed immediately.

The manager node 110 may not simply consider the resource availability of each computing device 130, but may also weigh the priority of the task against the number of other tasks and the priority of other tasks in each computing device 130's IETQ 118 as well as the number and priority of each task each computing device 130 is currently executing. For each of the identified subset of computing devices 130, the manager node 110 may analyze the number of and priority of other tasks in that computing device 130's IETQ 118. If there are no other high priority tasks in e.g., computing device 130A's IETQ 118A (and all other computing devices 130 do have high priority tasks), then the manager node 110 may select the computing device 130A. If all computing devices 130 do have high priority tasks in their respective IETQ 118, the manager node 110 may determine if it can modify the priority of a particular computing device 130's IETQ 118 to suit the priority needs of the new task 119 without compromising the priority needs of the other tasks in the particular computing device 130's IETQ 118 and while also maintaining the resource integrity of the computing device 130. The manager node 110 may modify the priority of a computing device 130's IETQ 118 by manually assigning the position of the new task 119 in the computing device 130's IETQ 118 and/or shifting the position of the other tasks in the computing device 130's IETQ 118. In some embodiments, the manager node 110 may change the priority of one or more other tasks in the computing device 130's IETQ 118 from high to medium or medium to low.

The manager node 110 may also modify the priority of a computing device 130's IETQ 118 by assigning the new task 119 and/or existing tasks within the IETQ 118 a higher or lower weight. Modifying the weight of a task may refer to modifying how the task itself operates. Modifications to the operation of a task may include the amount of compute resources available to the task (e.g., available RAM, disk space, CPU etc.), the frequency at which the task executes (if it is an on-going task) and whether the task can run alongside other tasks in a parallel manner or whether it should be the only task executed, for example. For example, a computing device 130 may execute a task that involves performing a computationally intensive database update at periodic intervals. When lowering the weight of such a task, the manager node 110 may decrease the frequency at which such database updates occur.

The manager node 110 may also consider the number and priority of each task each computing device 130 is currently executing. For example, if a computing device 130 is periodically executing a large number of on-going tasks at different frequencies, the manager node 110 may determine that the resource availability of the computing device 130 (even one that currently has sufficient resources to execute the new task 119) changes too frequently to reliably execute the new task 119 and may look to assign the new task 119 to a different computing device 130.

The manager node 110 may also consider the specific resources required for a particular task as well as the availability of each particular resource of a computing device 130 when making task assignment decisions. For example, the manager node 110 may determine (based on device metrics/context received from computing device 130C) that the computing device 130C does not have a significant number of resources available overall, but does currently have a large amount of bandwidth and RAM. If the manager node 110 receives a new task that requires significant bandwidth and RAM, but does not require significant amounts of other types of resources, then it may still assign the new task to the computing device 130C after considering the priority of tasks in the IETQ 118 of computing device 130C and the resource availability/current workload of other computing devices 130.

In the example of FIG. 3, the manager node 110 may determine that computing device 130A is the optimal computing device 130 for executing the new task because it has sufficient resource availability and few other high priority tasks. The ansible manager 110 may also determine that the new task 119 can be moved to the front of the IETQ 118A before the other high priority tasks currently within the IETQ 118A without compromising the priority needs of these other high priority tasks. The manager node 110 may deploy the new task 119 to the computing device 130A and indicate that the IETQ 118A is to be modified so that the new task 119 is at the front of the IETQ 118A. In some embodiments, the manager node 110 may deploy the new task 119 to the computing device 130A using an Ansible playbook. The computing device 130A may update its IETQ 118A with the refreshed priority, execute the new task 119 and send updated device metrics back to the manager node 110. This cycle continuously repeats, optimizing task distribution and system maintenance across the network of computing devices 130, thereby improving overall system performance and maintainability.

In some embodiments, upon receiving updated device metrics from a computing device 130, the manager node 110 may compare the received device metrics to an optimal state to identify deltas with respect to the computing device 130's capabilities. The optimal state for each computing device 130 may be defined in a respective configuration profile that provides optimal benchmarks with respect to resource availability of a computing device 130 (e.g., optimal battery, optimal computing power (e.g., optimal processing cores, optimal CPU cycles), optimal memory, and optimal bandwidth among others). The configuration profile of a computing device 130 may also provide minimum benchmarks with respect to resource availability. The manager node 110 may compare the device metrics of the computing device 130 with its respective configuration profile and in response to determining that the computing device 130 does not meet the minimum performance benchmarks (or is approaching the minimum performance benchmarks), it may restrict the computing device 130 from being assigned any further tasks. In some embodiments, if the manager node 110 determines the computing device 130 is reaching a critical battery level, it may decommission the computing device 130.

In some embodiments, if the manager node 110 determines that a computing device 130's resource availability is falling and approaching its minimum performance benchmarks (e.g., after analyzing successive updated device metrics), it may modify the priority of one or more tasks in the computing device 130's IETQ 118. For example, computing device 130B may be executing a task that involves reporting data from a sensor (not shown) to the manager node 110 every two seconds. If the manager node 110 determines that the battery level of computing device 130B is approaching its minimum performance benchmark, it may alter the weight of the task so that the computing device 130B only reports data from the sensor every 5 seconds, thereby utilizing the antenna of computing device 130B less and preserving its battery. This ability to decommission a computing device 130 or modify the priority of tasks being executed by the computing device 130 is important because a computing device 130 that does not meet its respective minimum performance benchmarks is in danger of breaching any service level agreements (SLAs) and/or providing a poor customer experience.

By being able to influence both the IETQ 118 of a computing device 130 and hence deprioritize actions that will have a more negative impact on the device, we can preserve the integrity of the device. Preserving integrity by manipulating an IETQ 118 (local queue) combined with the concept of a gETQ 117 (global queue) allows the manager node 110 to not target computing devices/execution nodes 130 that will be compromised by the task and will result in the task being performed poorly. Simultaneously, the manager node 110 may also ensure that there is a high level of prioritization of tasks that are mission critical.

The manager node 110 can prioritize tasks that have administrative priority such as CVE updates, software/firmware updates and decommissioning devices that are low on battery. This would enhance the general fleet management capabilities to ensure that task prioritization for the whole network of computing devices 130 gets the appropriate attention and priority and could govern use cases from load balancing to redundancy/failover scenarios in a pre-emptive and controlled manner. Using an automation controller as the task assigning entity saves resources in a light-weight manner and can ensure footprint awareness is at the forefront of the implementation.

The automation controller 114 may have a number of properties that enhance its ability to perform the task assignment techniques described above. One such property is that of a dynamic inventory, which supports an ever changing and dynamic network topology that is not uncommon in edge architectures where nodes can come and go (i.e., due to being located in volatile environments where nodes can be completely offline or isolated for short to long periods of times, with the effect of altering the topology of the network of managed nodes). This enables the automation controller 114 to decommission nodes/computing devices 130 and bring them back up again with ease. In addition, the use of a dynamic inventory also allows the manager node 110 to mark as unavailable not just the computing devices 130 that might be physically offline, but also the computing devices 130 that might be logically offline such as those that are restricted from being assigned any further tasks or those with security that is known to be compromised.

Another property of the automation controller 114 that enhances its ability to perform the task assignment techniques described above is idempotency. Idempotency means that a task is guaranteed to not execute more than once. Stated differently, idempotency guarantees that the automation controller 114 will prevent subsequent execution of a task after the first execution. Thus, when assigning a task, the automation controller 114 may determine if the same task with the same parameters has already been previously executed and if it has, determine that the task does not need to run again. This minimizes the complexity of dealing with messaging and queue tasks. For example, after executing a task involving e.g., “add_user Alice to system X,” the user does not need to worry about invoking the task more than once as the automation controller 114 has idempotency. If the task is invoked again, the automation controller 114 will not execute it.

This saves execution time and resources, especially if the same task is broadcast multiple times (e.g., if the task requestor assumed a failure). The automation controller 114 may leverage this property as a fail-safe measure to avoid having to enforce “exactly once” semantics in the queue processing. This may allow duplication of units of work that should be rare or infrequent, but whose eventual occurrence won't introduce a logical error leading to a corrupted state.

In some embodiments, the automation controller 114 can may use semantic tagging of certain tasks to allow edge cases where it may be desirable to execute those certain tasks again (e.g., if a certain time period has passed). The automation controller 114 may be any appropriate automation tool that has the idempotency property, such as Red Hat Ansible, as discussed hereinabove. In some embodiments, the automation controller 114 may not have the idempotency property, and thus the manager node 110 may provide a service (not shown) that filters duplicated instructions and includes logic to determine when executing the same task twice is desired. In other embodiments, the automation controller 114 may not have the idempotency property, and user scripts will need to include programming logic to check if the task has already been executed (e.g., “IF Alice IS NOT already a user THEN create_user Alice”).

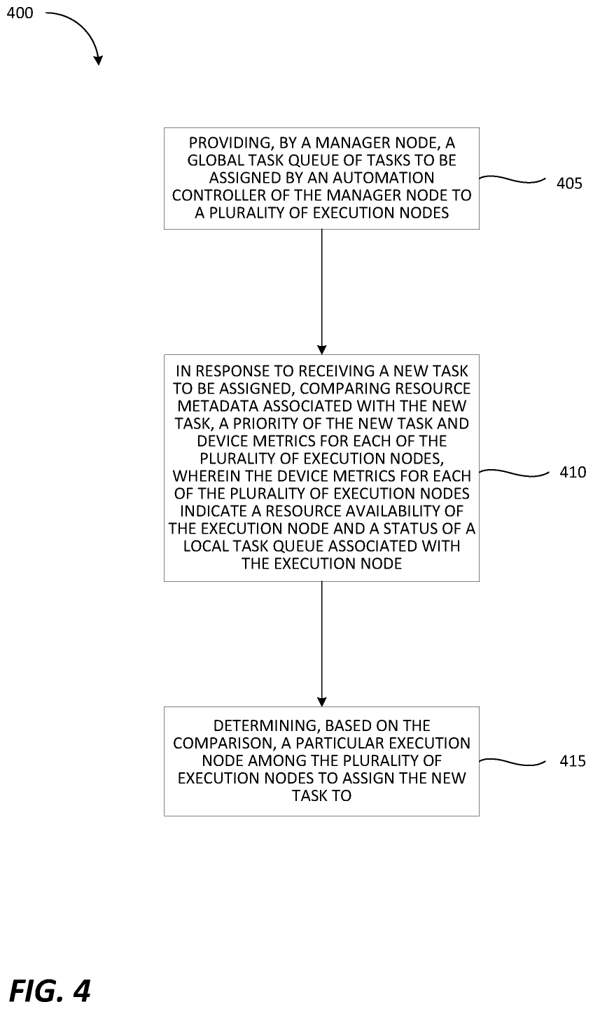

FIG. 4 is a flow diagram of a method 400 for assigning tasks using an automation controller, in accordance with some embodiments of the present disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the method 400 may be performed by a computing device (e.g., computing device 110 illustrated in FIGS. 1-3).

Referring also to FIGS. 2 and 3, at block 405 the manager node 110 may implement a global edge task queue (gETQ) 117 that includes a master set of tasks that need to be performed (have yet to be assigned), and may potentially be performed on any of the computing devices 130. Example tasks include CVE updates, firmware updates, building a database, retrieving a record, and polling data from a sensor. Each computing device 130 may implement a local edge task queue (IETQ) 118 that includes a set of tasks that have been assigned to the computing device 130 for execution. Each computing device 130's IETQ 118 may function both as a runtime log to keep track of the work the computing device 130 device is doing, but also to provide information for the manager node 110 to understand the computing device 130's workload as discussed in further detail herein.

When a computing device 130 completes a task, it may send device metrics including current resource availability and information about its current workload to the manager node 110. It should be noted that some tasks may not be simply executed once and completed, but may be on-going tasks such as polling data from a sensor. For these types of tasks, the computing device 130 may send device metrics once it has begun executing the task (to account for the resources used executing the task) and periodically thereafter. The information about a computing device 130's current workload may include the number of tasks it is currently executing and information indicating a number of tasks currently in its IETQ 118 and the priority of each of the tasks currently in its IETQ 118. The resource availability of a computing device 130 may include availability of resources of the computing device 130 such as available battery, available computing power (e.g., available processing cores, available CPU cycles), available memory, and available bandwidth among others. For example, a computing device 130 may send device metrics indicating e.g., that it is at 20% battery, currently has 1 processing core available, currently has 2 MB of ram available, currently has 300 MB of bandwidth available, is currently executing two other tasks (and the type/priority of tasks it is executing), and currently has 3 additional tasks in its IETQ 118 (and the type/priority of the tasks in its IETQ 118).

At block 410, as shown in FIG. 3, when a new task 119 is received by the manager node 110, the manager node 110 may put the new task into the gETQ 118 and may assess the new task's priority and the status of all computing devices 130 (based on the most recently received device metrics of each computing device 130). More specifically, the manager node 110 may compare the task profile of the new task 119 and the assessed priority of the new task 119 with the device metrics of each the computing devices 130 to determine the optimal computing device 130 to assign the new task to.

At block 415, the manager node 110 may compare the task profile of the new task 119 to the device metrics for each computing device 130 to determine a subset of computing devices 130 that currently have sufficient available resources to execute it. This is because the new task 119 is high priority, and so the manager node 110 may only consider computing devices 130 that currently have sufficient resources to execute it. However, if a new task is medium or low priority, the manager node 110 may consider computing devices 130 that do not currently have sufficient resources. For example, if all computing devices 130 are currently resource strained, the manager node 110 may assign the new task to the computing device 130 with the shortest IETQ 118 since the new task is medium or low priority and therefore does not need to be executed immediately.

The manager node 110 may not simply consider the resource availability of each computing device 130, but may also weigh the priority of the task against the number of other tasks and the priority of other tasks in each computing device 130's IETQ 118. For each of the identified subset of computing devices 130, the manager node 110 may analyze the number of and priority of other tasks in that computing device 130's IETQ 118. If there are no other high priority tasks in e.g., computing device 130A's IETQ 118A (and all other computing devices 130 do have high priority tasks), then the manager node 110 may select the computing device 130A. If all computing devices 130 do have high priority tasks in their respective IETQ 118, the manager node 110 may determine if it can modify the priority of a particular computing device 130's IETQ 118 to suit the priority needs of the new task 119 without compromising the priority needs of the other tasks in the particular computing device 130's IETQ 118 and while also maintaining the resource integrity of the computing device 130. The manager node 110 may modify the priority of a computing device 130's IETQ 118 by manually assigning the position of the new task 119 in the computing device 130's IETQ 118 and/or shifting the position of the other tasks in the computing device 130's IETQ 118. In some embodiments, the manager node 110 may change the priority of one or more other tasks in the computing device 130's IETQ 118 from high to medium or medium to low.

The manager node 110 may also modify the priority of a computing device 130's IETQ 118 by assigning the new task 119 a higher weight and/or assigning existing tasks within the IETQ 118 a lower weight. Modifying the weight of a task may refer to modifying how the task itself operates. For example, a computing device 130 may execute a task that involves performing a computationally intensive database update at periodic intervals. When lowering the weight of such a task, the manager node 110 may decrease the frequency at which such database updates occur.

The manager node 110 may also consider the number and priority of each task each computing device 130 is currently executing. For example, if a computing device 130 is periodically executing a large number of on-going tasks at different frequencies, the manager node 110 may determine that the resource availability of the computing device 130 (even one that currently has sufficient resources to execute the new task 119) changes too frequently to reliably execute the new task 119 and may look to assign the new task 119 to a different computing device 130.

The manager node 110 may also consider the specific resources required for a particular task as well as the availability of each particular resource of a computing device 130 when making task assignment decisions. For example, the manager node 110 may determine (based on device metrics/context received from computing device 130C) that the computing device 130C does not have a significant number of resources available overall, but does currently have a large amount of bandwidth and RAM. If the manager node 110 receives a new task that requires significant bandwidth and RAM, but does not require significant amounts of other types of resources, then it may still assign the new task to the computing device 130C after considering the priority of tasks in the IETQ 118 of computing device 130C and the resource availability/current workload of other computing devices 130.

In the example of FIG. 3, the manager node 110 may determine that computing device 130A is the optimal computing device 130 for executing the new task because it has sufficient resource availability and few other high priority tasks. The ansible manager 110 may also determine that the new task 119 can be moved to the front of the IETQ 118A before the other high priority tasks currently within the IETQ 118A without compromising the priority needs of these other high priority tasks. The Manager node 110 may deploy the new task 119 to the computing device 130A and indicate that the IETQ 118A is to be modified so that the new task 119 is at the front of the IETQ 118A. In some embodiments, the Manager node 110 may deploy the new task 119 to the computing device 130A using an Ansible playbook. The computing device 130A may update its IETQ 118A with the refreshed priority, execute the new task 119 and send updated device metrics back to the manager node 110. This cycle continuously repeats, optimizing task distribution and system maintenance across the network of computing devices 130, thereby improving overall system performance and maintainability.

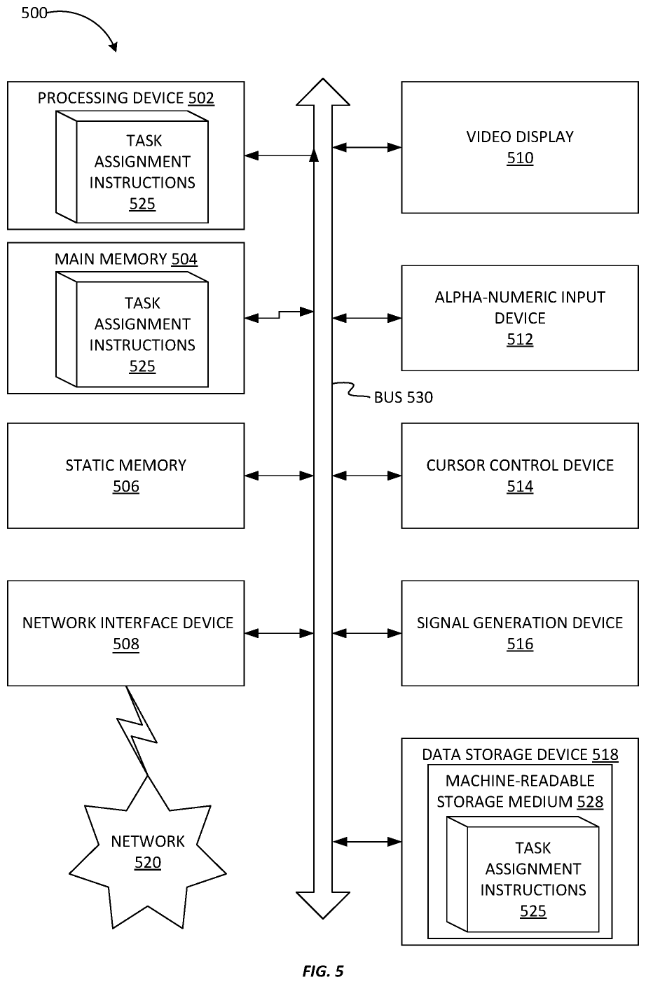

FIG. 5 illustrates a diagrammatic representation of a machine in the example form of a computer system 500 within which a set of instructions, for causing the machine to perform any one or more of the methodologies discussed herein for assigning tasks using an automation controller, in accordance with some embodiments of the present disclosure.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 500 may be representative of a server.

The exemplary computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 500 may further include a network interface device 508 which may communicate with a network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In one embodiment, video display unit 510, alphanumeric input device 512, and cursor control device 514 may be combined into a single component or device (e.g., an LCD touch screen).

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute task assignment instructions 525, for performing the operations and steps discussed herein.

The data storage device 518 may include a machine-readable storage medium 528, on which is stored one or more sets of task assignment instructions 525 (e.g., software) embodying any one or more of the methodologies of functions described herein. The task assignment instructions 525 may also reside, completely or at least partially, within the main memory 504 or within the processing device 502 during execution thereof by the computer system 500; the main memory 504 and the processing device 502 also constituting machine-readable storage media. The task assignment instructions 525 may further be transmitted or received over a network 520 via the network interface device 508.

The machine-readable storage medium 528 may also be used to store instructions to perform a method for assigning tasks using an automation controller. While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “providing,” “comparing,” “determining,” “deploying,” “modifying” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
providing, by a manager node, a global task queue of tasks to be assigned by an automation controller of the manager node to a plurality of execution nodes;
in response to receiving a new task to be assigned, comparing resource metadata associated with the new task, a priority of the new task and device metrics for each of the plurality of execution nodes, wherein the device metrics for each of the plurality of execution nodes indicate a resource availability of the execution node and a status of a local task queue associated with the execution node; and
determining, based on the comparison, a particular execution node among the plurality of execution nodes to assign the new task to.

2. The method of claim 1, wherein for each of the plurality of execution nodes, the status of the associated local task queue comprises:
a number of tasks currently within the associated local task queue; and
a priority of each task currently within the associated local task queue.

3. The method of claim 2, wherein determining the particular execution node comprises:
determining that the priority of one or more tasks currently within the associated local task queue of the particular execution node can be modified so that the particular execution node prioritizes the new task.

4. The method of claim 2, further comprising:
deploying the new task to the particular execution node;
modifying the priority of one or more tasks currently within the associated local task queue of the particular execution node based on the comparison;
executing, by the particular execution node, the new task; and
sending updated device metrics to the manager node.

5. The method of claim 4, wherein the new task is deployed to the particular execution node using an Ansible playbook.

6. The method of claim 1, further comprising:
receiving updated device metrics from a first execution node of the plurality of execution nodes;
comparing the updated device metrics of the first execution node with a configuration profile of the first execution node, wherein the configuration profile indicates minimum resource thresholds that the first execution node must maintain; and
in response to determining that the first execution node does not meet the minimum resource thresholds, decommissioning the first execution node.

7. The method of claim 1, further comprising:
receiving updated device metrics from a first execution node of the plurality of execution nodes;
comparing the updated device metrics of the first execution node with a configuration profile of the first execution node, wherein the configuration profile indicates minimum resource thresholds that the first execution node must maintain; and
in response to determining that the first execution node is approaching the minimum resource thresholds, modifying a priority of one or more tasks being executed by the first execution node.

8. A system comprising:
a memory; and
a processing device operatively coupled to the memory, the processing device to:
provide, by a manager node, a global task queue of tasks to be assigned by an automation controller of the manager node to a plurality of execution nodes;
in response to receiving a new task to be assigned, compare resource metadata associated with the new task, a priority of the new task and device metrics for each of the plurality of execution nodes, wherein the device metrics for each of the plurality of execution nodes indicate a resource availability of the execution node and a status of a local task queue associated with the execution node; and
determine, based on the comparison, a particular execution node among the plurality of execution nodes to assign the new task to.

9. The system of claim 8, wherein for each of the plurality of execution nodes, the status of the associated local task queue comprises:
a number of tasks currently within the associated local task queue; and
a priority of each task currently within the associated local task queue.

10. The system of claim 9, wherein to determine the particular execution node, the processing device is to:
determine that the priority of one or more tasks currently within the associated local task queue of the particular execution node can be modified so that the particular execution node prioritizes the new task.

11. The system of claim 9, wherein the processing device is further to:
deploy the new task to the particular execution node;
modify the priority of one or more tasks currently within the associated local task queue of the particular execution node based on the comparison;
execute, by the particular execution node, the new task; and
send updated device metrics to the manager node.

12. The system of claim 11, wherein the processing device deploys the new task to the particular execution node using an Ansible playbook.

13. The system of claim 8, wherein the processing device is further to:
receive updated device metrics from a first execution node of the plurality of execution nodes;
compare the updated device metrics of the first execution node with a configuration profile of the first execution node, wherein the configuration profile indicates minimum resource thresholds that the first execution node must maintain; and
in response to determining that the first execution node does not meet the minimum resource thresholds, decommission the first execution node.

14. The system of claim 8, wherein the processing device is further to:
receive updated device metrics from a first execution node of the plurality of execution nodes;
compare the updated device metrics of the first execution node with a configuration profile of the first execution node, wherein the configuration profile indicates minimum resource thresholds that the first execution node must maintain; and
in response to determining that the first execution node is approaching the minimum resource thresholds, modify a priority of one or more tasks being executed by the first execution node.

15. A non-transitory computer-readable medium having instructions stored thereon which, when executed by a processing device, cause the processing device to:
provide, by a manager node, a global task queue of tasks to be assigned by an automation controller of the manager node to a plurality of execution nodes;
in response to receiving a new task to be assigned, compare resource metadata associated with the new task, a priority of the new task and device metrics for each of the plurality of execution nodes, wherein the device metrics for each of the plurality of execution nodes indicate a resource availability of the execution node and a status of a local task queue associated with the execution node; and
determine, based on the comparison, a particular execution node among the plurality of execution nodes to assign the new task to.

16. The non-transitory computer-readable medium of claim 15, wherein for each of the plurality of execution nodes, the status of the associated local task queue comprises:
a number of tasks currently within the associated local task queue; and
a priority of each task currently within the associated local task queue.

17. The non-transitory computer-readable medium of claim 16, wherein to determine the particular execution node, the processing device is to:
determine that the priority of one or more tasks currently within the associated local task queue of the particular execution node can be modified so that the particular execution node prioritizes the new task.

18. The non-transitory computer-readable medium of claim 16, wherein the processing device is further to:
deploy the new task to the particular execution node;
modify the priority of one or more tasks currently within the associated local task queue of the particular execution node based on the comparison;
execute, by the particular execution node, the new task; and
send updated device metrics to the manager node.

19. The non-transitory computer-readable medium of claim 18, wherein the processing device deploys the new task to the particular execution node using an Ansible playbook.

20. The non-transitory computer-readable medium of claim 15, wherein the processing device is further to:
receive updated device metrics from a first execution node of the plurality of execution nodes;
compare the updated device metrics of the first execution node with a configuration profile of the first execution node, wherein the configuration profile indicates minimum resource thresholds that the first execution node must maintain; and
in response to determining that the first execution node does not meet the minimum resource thresholds, decommission the first execution node.
